(19) United States
(12) Patent Application Publication
(10) Pub. No.: US 2014/0093797 A1
(43) Pub. Date: Apr. 3, 2014

(54) Recirculation Unit For a Fuel Cell System

(71) Applicant: Armin Muetschele, Weilheim an der Teck (DE)

(72) Inventor: Armin Muetschele, Weilheim an der Teck (DE)

(73) Assignee: Daimler AG, Stuttgart (DE)

(21) Appl. No.: 14/119,840

(22) PCT Filed: May 4, 2012
(86) PCT No.: PCT/EP2012/001934

§ 371 Date: Nov. 22, 2013

(30) Foreign Application Priority Data
May 25, 2011 (DE) 10 2011 102 336.8

(51) Int. Cl. H01M 8/04

(52) U.S. Cl. CPC H01M 8/04097
USPC 429/415

(57) ABSTRACT

A recirculation device for a fuel cell system includes a recirculation line connecting the outlet and inlet of the anode region of the fuel cell. The recirculation device includes a liquid separator situated in the area of the recirculation line and a discharge line having a discharge valve for liquid and/or gases. A bubble sensor for controlling the discharge valve is situated in the area of the discharge line. A method for discharging liquid and/or gases from a recirculation device opens and closes the discharge valve as a function of an event detected by the bubble sensor.

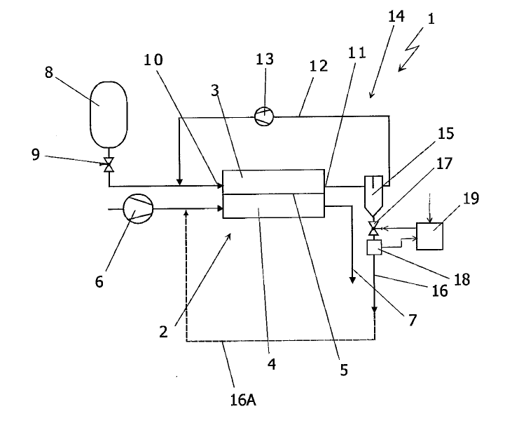

### BACKGROUND AND SUMMARY OF THE INVENTION

Exemplary embodiments of the present invention relate to a recirculation device for a fuel cell system.

Fuel cell systems operated with gaseous starting products, for example air and hydrogen or hydrogen-containing gas, are known from the general prior art. They generally have at least one fuel cell with an anode region and a cathode region. The fuel cell is typically designed as a stack of individual fuel cells, and is referred to as a fuel cell stack. In fuel cells of this type, in particular those designed in PEM technology, the exhaust gas from the anode region is often collected and resupplied, together with fresh gas, in particular fresh hydrogen, to the anode region. A recirculation device is necessary for this purpose.

This type of recirculation device is described using name “fuel circuit” in PCT Publication No. WO 2008/052578 A1. In this recirculation device, exhaust gas from the anode region of the fuel cell is led through a liquid separator and, mixed with fresh gas flowing to the fuel cell, is resupplied to the anode region. A recirculation conveying device may be provided to compensate for the pressure losses in the area of the recirculation line and the anode region. This recirculation conveying device is known in the general prior art, and is typically designed as a blower and/or gas jet pump.

Over time, inert gases and water accumulate in the exhaust gas stream that is returned to the inlet of the anode region. This water is separated from the gas stream by means of the liquid separator to prevent “flooding” of the anode region with the water. The inert gases, in particular nitrogen, which diffuse from the cathode region into the anode region through the membranes of the fuel cell accumulate in the recirculation device over time, resulting in a drop in the hydrogen concentration. Therefore, water and inert gas must be occasionally discharged from the circuit of the recirculation device to ensure good performance of the fuel cell.

To this end, PCT Publication No. WO 2008/052578 A1 describes a discharge valve in a discharge line from the liquid separator. The discharge valve may be controlled, for example, as a function of filling level sensors or level sensors in the liquid separator. The objective is always to completely remove the water from the region of the circuit and to subsequently fully evacuate the inert gases without releasing too much hydrogen to the environment.

It has now been shown that the filling level sensors, which typically have a capacitive design, have a pronounced tendency toward contamination, as the result of which their functionality is very unreliable.

In practice, the discharge valve is therefore frequently operated in a time-controlled manner, for example in order to be occasionally opened and then closed after a certain period. By use of characteristic maps or experiments, the times are designed in such a way that the water is completely removed, and in any case all of the inert gas is removed without releasing too much hydrogen. Since the fuel cell may be operated in different load states, and in particular when used in a vehicle is typically operated in a very dynamic manner, the quantity of resulting water, which occurs as a function of the power and the amount of hydrogen consumed in the anode region, often varies greatly. When strictly time control is used, this frequently results in problems due to excessive water in the circuit of the recirculation device. Since liquid water may block the active surface of the anode region when it penetrates into the anode region, this is very disadvantageous for the performance of the fuel cell. Therefore, the time control in any case is designed in such a way that the liquid water is always completely removed. In part load operation, however, the time periods are then so long that a comparatively large quantity of hydrogen is also lost, which is undesirable.

Another option for improving the switching of the discharge valve is to predict the resulting quantity of water by determining in advance and adding the quantity of water produced in the anode region for the particular power that is present. As soon as an appropriate quantity of water has accumulated in the circuit of the recirculation device the discharge valve is then opened for a period corresponding to this quantity of water. This improves the functionality compared to opening of the discharge valve in a strictly time-controlled manner. However, fluctuations and inaccuracies are still present, so that here as well, more hydrogen is lost than is desired, since for the same reasons as described above, a certain safety margin in the opening time must always be maintained so that in any case, all of the water is discharged from the region of the recirculation device.

Other typical options for improving the control are to provide hydrogen sensors in the discharge line downstream from the valve device. However, these are comparatively complex and costly, and susceptible to malfunction.

Another option is described in German patent application DE 10 2009 036 197 A1, which dispenses with a hydrogen sensor and instead the discharged media stream is led into the region of the cathode or the air inlet flowing to the cathode. When hydrogen arrives in the region of the cathode, this results in a voltage dip in the fuel cell, which is particularly apparent in part load operation. This arrival of hydrogen on the cathode side indicates that water and inert gases have been discharged. The discharge valve may then be closed.

This method also has the major disadvantage that significantly more hydrogen is lost than is necessary, since the hydrogen must first overcome the line length between the discharge valve and the cathode region, and only then can it be detected. Thus, the hydrogen present in this line length invariably goes to waste during each discharge operation.

Exemplary embodiments of the present invention are directed to a recirculation device for a fuel cell system that operates securely and reliably and that has a simple and efficient design. Exemplary embodiments of the present invention are also directed to a method for discharging liquid and/or gases from such a recirculation device, which minimizes the losses of hydrogen.

The recirculation device according to exemplary embodiments of the invention for a fuel cell system necessarily includes a recirculation line connecting the outlet of the anode region of the fuel cell to the inlet thereof. A liquid separator is situated in the area of this recirculation line, and has a discharge line having a discharge valve for liquid and/or gas. According to the invention, a bubble sensor for controlling the discharge valve is situated in the area of the discharge line. By use of such a bubble sensor, a distinction may be easily and very efficiently made between liquid flowing in the discharge line and gas flowing in the discharge line. The boundary between the flowing liquid and the gas following same may thus be recognized and detected using such a bubble sensor, and may be used for controlling the discharge valve. The sensor may in particular have a contactless design, preferably as an ultrasonic sensor, an optical sensor, or the like. A bubble sensor of this type having high reliability and high resolution is available on the market at low cost, so that a simple, reliable, and cost-effective implementation of the recirculation device for the fuel cell system is possible.

According to one particularly favorable and advantageous refinement of the recirculation device according to the invention, the bubble sensor may be situated downstream from the discharge valve, in the area of the discharge line in the direction of flow of the discharged volumetric flow. The crucial transition from liquid to gas may be detected in particular in this area downstream from the discharge valve, which then results in closing of the discharge valve and termination of the discharge operation. The quantity of hydrogen that is evacuated during the discharge may be correspondingly minimized.

As previously mentioned, the bubble sensor may preferably be designed as a contactless bubble sensor. This results in a simple and efficient design, which is very favorable with regard to contamination because the bubble sensor typically surrounds the discharge line only from the outside, and therefore does not come into contact with the medium flowing in the discharge line. Contamination via this medium is thus ruled out, and without this contamination the bubble sensor functions securely and reliably, unlike the capacitive filling level sensors known from the prior art, which are situated in the volumetric flow.

The method according to the invention provides for the discharge valve to be opened, and then closed as a function of an event detected by the bubble sensor.

Thus, in the method according to the invention the discharge valve is opened according to any given strategy as known from the prior art, for example. This may be, for example, a time-controlled opening, or alternatively, of course, may be an opening based on a predicted quantity of water in the recirculation device, or also based on a characteristic curve, for example between the power delivered by the fuel cell and a power averaged or summed over the particular time period for a typical time span. When the discharge valve is opened in this manner, known per se, it remains open until the bubble sensor detects an appropriate event, on the basis of which the discharge valve is then closed.

In one particularly favorable and advantageous refinement of the method according to the invention, the bubble sensor is calibrated in such a way that it detects the transition between the discharged liquid and the discharged gas which follows same. Such an event, which indicates that the liquid is completely discharged, is then used to close the discharge valve. Depending on the position of the bubble sensor, preferably in the direction of flow, directly downstream from the discharge valve or at a certain distance downstream from the discharge valve in the direction of the volumetric flow, in any case the discharge valve is not closed until the gas has arrived in the area of the bubble sensor, and thus, the liquid has been completely discharged from the liquid separator. The discharge valve may then either be closed directly, which is particularly advantageous when there is an appropriate distance between the discharge valve and the bubble sensor, or closed in an appropriate time-delayed manner, which is particularly advantageous when the bubble sensor is situated directly downstream from the discharge valve. It may thus always be ensured that a certain quantity of gas is discharged, so that the inert gases in addition to the discharged water have been securely and reliably removed from the recirculation device.

In the described design, the predefined time period and/or the distance between the bubble sensor and the discharge valve is/are a determining factor in the quantity of discharged gas, and thus possibly also the quantity of escaped hydrogen. To minimize this, in one particularly favorable and advantageous refinement of the design according to the invention it is provided that, when the pressure difference over the discharge valve is known or measured, and the flow cross section in the area of the discharge valve is known from the time period between the opening of the discharge valve and the detection of gas in the area of the bubble sensor and possibly the distance of the flow between the discharge valve and the bubble sensor, the quantity of liquid discharged is determined, and a time which is predefined as a function of the discharged quantity of liquid is awaited until the discharge valve is closed. Since the actual quantity of liquid present is always a function of the instantaneous operating conditions of the fuel cell and in particular the power demand on the fuel cell, the quantity of inert gas present in the recirculation device is also a function of the quantity of liquid discharged. If the predefined time between the detection of the gas in the discharge line and the closing of the discharge valve is now defined as a function of the quantity of liquid discharged, for example by means of a characteristic curve, the entire quantity of inert gas may always be securely and reliably discharged without more hydrogen escaping than is absolutely necessary.

The recirculation device according to the invention as well as the method for discharging liquid and/or gases are very efficient, reliable, and easy and cost-effective to realize and implement. The recirculation device and the method are therefore particularly suited for use in fuel cell systems which generate electrical power, in particular for drive purposes, in a motor vehicle.

In particular for vehicle applications and the associated unit quantities, the simple and cost-effective design is extremely important. Likewise, reliable functionality is crucial in order to minimize repairs and service and to be able to achieve the longest possible maintenance intervals for the motor vehicles.

Further advantageous embodiments of the recirculation device according to the invention and of the method according to the invention for discharging liquid and/or gases from such a recirculation device result from the exemplary embodiment which is described in greater detail below with reference to the sole FIGURE.

### BRIEF DESCRIPTION OF THE DRAWING FIGURE

The sole FIGURE schematically illustrates a fuel cell system and the parts of such a fuel cell system necessary for the invention.

### DETAILED DESCRIPTION

The sole FIGURE schematically illustrates a fuel cell system 1. The core of this fuel cell system 1 is a fuel cell 2, which is designed as a stack of individual fuel cells, referred to as a so-called fuel cell stack. The fuel cell 2 includes an anode region 3 and a cathode region 4 separated from one another by a proton-conducting membrane 5. The fuel cell 2 is accordingly a PEM fuel cell. The cathode region 4 of the fuel cell 2 is supplied, via an air conveying device 6, with filtered air as an oxygen-containing medium. Spent exhaust air passes from the fuel cell system 1 via an exhaust air line 7. The exhaust air may be discharged to the environment, expanded through a turbine, and/or supplied to combustion. However, this is not significant for the invention.

The anode region 3 of the fuel cell 2 is supplied with hydrogen from a compressed gas store 8 via a valve and pressure regulation device 9. The fresh hydrogen flows through a supply line to the inlet 10 of the anode region 3, and in the anode region 3 is partially reacted with the oxygen from the cathode region 4 to produce electrical power and product water. The unreacted hydrogen passes through an outlet 11 of the anode region 3 into a recirculation line 12, via which the hydrogen is introduced into the area of the fresh gas stream flowing to the inlet 10 of the anode region 3 via a recirculation conveying device 13. The recirculation conveying device 13 may be designed in a manner known per se as a recirculation blower and/or as one or more gas jet pumps, which are typically driven by the fresh gas stream originating from the compressed gas store 8. In addition to the recirculation line 12 and the recirculation conveying device 13, a recirculation device 14 for the fuel cell system 1 includes a liquid separator 15 in the area of the recirculation line 12. This liquid separator 15 is used for separating liquid, in particular product water in the gas stream of the recirculation device 14. The separated water collects in the liquid separator 15 and is occasionally discharged via a discharge line 16 having a discharge valve 17 in order to empty the liquid separator 15 and to blow off inert gases which collect over time around the anode region 3 in the area of the recirculation device 14. The discharge line 16 conducts the discharged water and/or the discharged gases either to the environment, or, as illustrated by the dashed-line portion 16A of the discharge line 16, into the area of the air flowing to the cathode region 4.

In the area of the discharge line 16, the recirculation device 14 also has a bubble sensor 18 and a control electronics system 19 for evaluating the signals of the bubble sensor 18 and for controlling the discharge valve 17. The discharge valve 17 is designed as a simple on-off valve, and may preferably be implemented as a solenoid valve. The discharge valve may be appropriately controlled via the control system 19 in order to discharge the water and the inert gases from the area of the recirculation line 12. The discharge valve 17 may be opened in a manner known per se. In particular, the discharge valve 17 may be opened in a time-controlled manner, i.e., in each case after a predefined time period subsequent to the previous opening. Alternatively or additionally, the opening may be triggered by integrating the power delivered by the fuel cell 2, the discharge valve 17 always being opened after a certain amount of work has been performed by the fuel cell. Another option is to open the discharge valve 17 as a function of a predicted quantity of water that is present in the area of the recirculation line and the anode region, and thus ultimately in the area of the liquid separator 15. This quantity may be appropriately computed or estimated, for example, as a function of the power of the fuel cell, so that the discharge valve 17 may always be opened when a prediction or computation is made in advance that the liquid separator 15 is filled, for example up to two-thirds filled. Alternatives from the prior art that are also known options for generating a signal for opening the discharge valve 17 are likewise conceivable and possible.

The discharge valve 17 is then closed based on an event detected by the bubble sensor 18. The bubble sensor 18 should be designed as a contactless bubble sensor, preferably as an ultrasonic bubble sensor. Such an ultrasonic bubble sensor 18 may be arranged around the discharge line without having to interrupt the discharge line. The bubble sensor 18 may detect any bubbles in the discharged media stream through the walls of the discharge line 16 in a contactless manner. For this purpose, no connection is necessary between the bubble sensor 18 and the interior of the discharge line 16. Therefore, the bubble sensor 18 cannot be contaminated by the medium flowing in the discharge line 16. Bubble sensors 18 may be set to be very sensitive, for example to detect minimal bubble sizes in a liquid stream. In the present design of the recirculation device 14, the bubble sensor 18 should be calibrated in such a way that it detects a transition between the water from the liquid separator 15 and the inert gas following this water. Thus, the bubble sensor 18 always outputs an event when the entire quantity of water or liquid has passed through it, and the gas following the water, in particular inert gas here, flows through the discharge line 16. This event is then appropriately evaluated by the control system 19, and may be used either directly or in a time-delayed manner for closing the discharge valve 17.

The objective in closing the discharge valve 17 is always to discharge the entire quantity of water as well as the inert gases that have collected in the recirculation line 12 and the anode region 3, without any hydrogen, or no more hydrogen than absolutely necessary, passing to the environment or into the supply air stream to the cathode region 4.

In a first, very simple embodiment of the invention, this may be achieved in that the discharge valve 17 is always closed when the transition from the liquid to the gas has been detected by the bubble sensor 18. Depending on the position of the bubble sensor 18, which preferably is situated directly downstream from the discharge valve 17 or at a small distance downstream from the discharge valve 17 in the direction of flow, a certain quantity of gas, in the present case the quantity of inert gas that is typically present, then always already flows through the discharge valve 17 before the discharge valve is closed. If the distance of the discharge line between the discharge valve 17 and the bubble sensor 18 is not freely selectable so that the distance may form the time offset, such a time offset may also be appropriately specified, in addition to or instead of such a distance when the bubble sensor 18 is situated downstream from the discharge valve 17. This design ensures that the entire quantity of water that is present is always discharged. In addition, a small quantity of gas is also discharged, which typically could correspond to the quantity of inert gases which have accumulated.

However, in an enhanced embodiment the quantity of discharged water may be determined or determined very accurately by means of the bubble sensor 18. For this purpose, a pressure difference upstream and downstream from the discharge valve 17 is either measured or is already known based on the operating pressures of the fuel cell system 1. Together with the known flow cross section in the area of the discharge valve 17, the quantity of discharged liquid may be determined from the time period between the opening of the discharge valve 17 and the detection of the gas in the area of the bubble sensor 18, and optionally the distance of the flow between the discharge valve 17 and the bubble sensor 18. This may take place, for example, in the control system 19. The quantity of liquid discharged is typically correlated with the power demand on the fuel cell 2, and may vary greatly, for example for time-controlled opening of the discharge valve 17, depending on the dynamic requirements that have been imposed on the fuel cell 2. In addition to the quantity of the resulting water, however, the quantity of the resulting inert gas is also typically a function of such parameters. Based on the resulting quantity of water that may be determined in the above-described manner by means of the discharge time, the quantity of the inert gas present in the recirculation line 12 and the anode region 3 may now be easily deduced. When the predefined time until the closing of the discharge valve 17 after the event has been detected in the bubble sensor 18, i.e., now predefined as a function of the determined quantity of water, discharge of the inert gas may be securely and reliably ensured without any more hydrogen than absolutely necessary being discharged.

The design is particularly simple and is not susceptible to contamination and malfunction, since the bubble sensor 18 operates in a contactless manner and does not come into contact with the media stream in the discharge line 16. Therefore, the media stream also cannot contaminate the bubble sensor, as is the case, for example, when capacitive filling level sensors are used.

In summary, the recirculation device 14 of the described type as well as the described method for discharging liquid and/or gases from the area of the recirculation device 14 thus allow a simple and efficient design which operates securely and reliably and may be correspondingly implemented in a cost-effective manner. A fuel cell system 1 having a recirculation device 14 of this type may therefore preferably be used in high-load systems that are operated in a highly dynamic manner and which must be available at low cost in large unit quantities. One preferred application is use of the fuel cell system 1 in a motor vehicle, in particular for providing electrical power for driving the motor vehicle.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A recirculation device for a fuel cell system having a fuel cell which is operated with gaseous starting products and having an anode region and a cathode region, the recirculation device comprising:
a recirculation line which connects an outlet of the anode region to an inlet of the anode region;
a liquid separator arranged in an area of the recirculation line, wherein the liquid separator includes a discharge line comprising a discharge valve configured to discharge liquid or gas; and
a bubble sensor, which is configured to control the discharge valve, arranged in an area of the discharge line.

12. The recirculation device according to claim 11, wherein the bubble sensor is arranged downstream from the discharge valve, in an area of the discharge line in a direction of flow of the discharged liquid or gas.

13. The recirculation device according to claim 11, wherein the bubble sensor is a contactless bubble sensor.

14. The recirculation device according to claim 13, wherein the contactless bubble sensor is an ultrasonic sensor.

15. The recirculation device according to claim 11, wherein the bubble sensor externally surrounds the discharge line.

16. A method for discharging liquid or gas from a recirculation device for a fuel cell system having a fuel cell that is operated with gaseous starting products and having an anode region and a cathode region, the method comprising:
recirculating gas via a recirculation line which connects an outlet of the anode region to an inlet of the anode region;
separating liquid by a liquid separator arranged in an area of the recirculation line; and
discharging liquid or gas from the liquid separator via a discharge line comprising a discharge valve,
wherein the discharge value is control to open and close as a function of an event detected by a bubble sensor arranged in an area of the discharge line.

17. The method according to claim 16, wherein the bubble sensor is calibrated so that it detects a transition between discharged liquid and discharged gas.

18. The method according to claim 16, wherein the discharge valve is closed in a time-delayed manner after the event is detected by the bubble sensor.

19. The method according to claim 16, further comprising:
determining a quantity of the discharged liquid; and
closing the valve after a period of time of detecting the event, wherein the period of time is determined as a function of
the discharged quantity of liquid,
a known or measured pressure difference,
a flow cross section in the area of the discharge valve, and
a distance of the flow between the discharge valve and the bubble sensor.

20. A method according to claim 16, wherein the discharge valve is opened in a time-controlled manner as a function of summed power values of the fuel cell, or based on a computed quantity of liquid that is expected to be present in the recirculation device.
